(19) United States
(12) Patent Application Publication
(10) Pub. No.: US 2010/0263135 A1
(43) Pub. Date: Oct. 21, 2010

(54) PROCESS FOR PERMANENT BODY EPILATION

(76) Inventor: Paola Fontani, Monte San Savino (IT)

Correspondence Address: Modiano & Associati, Via Meravigli 16, Milano, 20123, IT

(21) Appl. No.: 12/735,194

(22) PCT Filed: Nov. 11, 2008
(86) PCT No.: PCT/EP2008/065326

§ 371 Date: Jun. 21, 2010

(30) Foreign Application Priority Data
Jan. 8, 2008 (IT) AR2008A000002

(51) Int. Cl. C14C 1/06

(52) U.S. Cl. 8/94.16

(57) ABSTRACT

A permanent body epilation process comprising a step for skin preparation, for cleansing and degreasing the cutaneous layer of the skin, and a step for the application, by means of a poration machine, of a liquid solution that comprises the active ingredient lauryl isoquinolinium bromide.

The present invention relates to a process for permanent body epilation.

### BACKGROUND OF THE INVENTION

Epilation consists in removing the hair in its entirety, down to the hair bulb.

Permanent body epilation systems are known, such as for example laser or coagulation of the blood vessels that feed the hair bulb.

However, these systems are scarcely effective and very expensive, require extremely long application times, and often have drawbacks of a physical type, such as for example small hematomas, rashes, abrasions, burns and, in the worst cases, blemishes and permanent traces that are visible on the skin.

As regards permanent laser epilation, for example, patients are forced to undergo treatment sessions even for a prolonged period, which can last up to a year, with a very low percentage of success.

Further, since the laser equipment is very sophisticated, this type of epilation is very costly.

As regards electrocoagulation, instead, although the costs are lower than laser epilation, the percentage of success is lower and treatment times are even longer and may sometimes be as long as five years.

### SUMMARY OF THE INVENTION

The aim of the present invention is to eliminate the above-mentioned drawbacks of known types of permanent body epilation processes, allowing a more effective result in almost all treatments and in shorter times than the mentioned known techniques.

Within this aim, an object of the invention is to provide a body epilation process that does not cause abrasions, irritations and rashes of the skin and most of all does not leave blemishes and burns on the skin.

Another object of the invention is to provide a permanent body epilation process by means of machines and products that are not sophisticated and are easily commercially available, so that the treatment has low costs.

This aim and these and other objects, which will become better apparent hereinafter, are achieved by a permanent body epilation process, according to the invention, characterized in that it comprises a step for skin preparation, for cleansing and degreasing the cutaneous layer of the skin, and a step for application, by means of a poration machine, of a liquid solution that comprises the active ingredient lauryl isoquinolinium bromide.

### BRIEF DESCRIPTION OF THE DRAWINGS

Further characteristics and advantages of the invention will become better apparent from the following detailed description of a preferred but not exclusive embodiment of the process for permanent body epilation, illustrated by way of non-limiting example in the accompanying drawings, wherein:

FIG. 1 is the flowchart of the epilation process;

FIG. 2 illustrates the step for opening the pores of the skin;

FIG. 3 illustrates the step for application of the liquid solution.

### DESCRIPTION OF THE PREFERRED EMBODIMENTS

With reference to the figures, the permanent body epilation process according to the invention, comprises a preparation step 1 (as shown in the flowchart of FIG. 1), which in turn comprises a skin peeling 1.1, a subsequent cleansing and degreasing of the cutaneous layer of the skin 1.2, a drying with talc 1.3, and finally a first temporary depilation 1.4.

The last step 1.4 is composed of three mutually successive stages and comprises an application of a hot liposoluble wax 1.4.a, a deposition of waxing strips 1.4.b so that they adhere in the best possible way to the wax applied to the skin, and a subsequent pulling of the strips 1.4.c.

Once the skin is sufficiently degreased and cleansed, so that its pores are free from any deposits that might block them, a step 2 for the application of a cathode 6 of a poration machine on the surface of the skin to be treated and the application of an anode 7 of such poration machine to the opposite part of the surface to be treated with respect to the application of the cathode 6 is performed.

The poration machine is a medical device which is already known and tested and is known commercially as Achtyderm Pulse and utilizes the phenomenon of electroporation of the skin for noninvasive infiltration and transport of drugs and cosmetics.

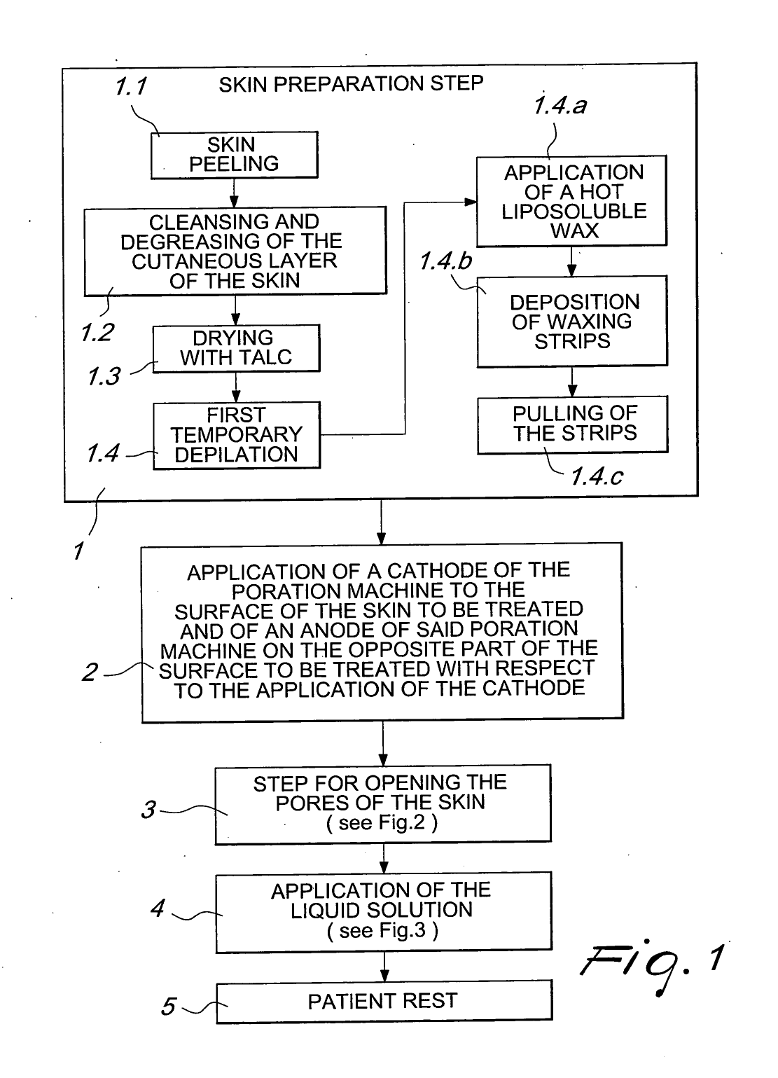

Advantageously, a step 3 for opening the pores of the skin is subsequently performed. With reference to FIG. 2, an electric pen 8 is connected to the cathode 6 of the poration machine and is passed over 5 and preferably 2-3 square centimeters of skin to be treated with the method according to the invention for approximately one minute, and one or more electrodes 9 are connected to the anode 7 on the opposite side of the body.

The electric pen 8, by passing over the skin, generates a transmembrane potential in epithelial cells. The double fatty layer of the cell is subjected to a temporary rearrangement, forming aqueous channels in the cell membrane, which are generally known as electropores. This alteration provide the cell membrane with higher permeability to a large variety of hydrophilic molecules that otherwise would not be able to enter the cell. Once formed, these electropores remain open for a long period with respect to the length of the pulse (generally from a few seconds to a few minutes).

At this point, after performing the step 3 for opening the pores of the skin, a step 4 for the application of the liquid solution, which has the compound lauryl isoquinolinium bromide as its active ingredient, by means of such poration machine, is performed.

The lauryl isoquinolinium bromide compound (also referenced as isoquinolinium 2-dodecyl bromide) is a compound that has a disinfectant action and is derived from isoquinolinium and therefore can be classed as a disinfectant in a very general sense. From a chemical standpoint, the compound belongs to the very general category of salts, since it is a bromide salt, and in particular the lauryl isoquinolinium compound and also its brominated salt can be defined as an aromatic organic compound.

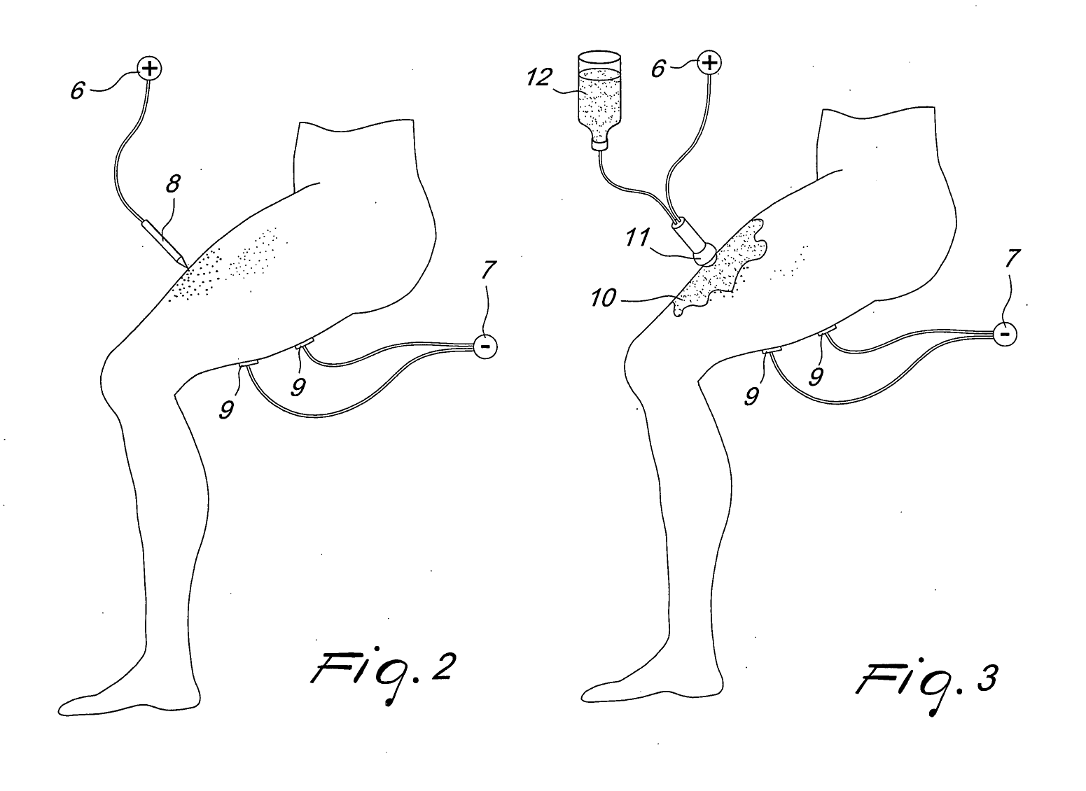

With reference to FIG. 3, a liquid solution 10, which comprises the active ingredient lauryl isoquinolinium bromide, is applied to the skin to be permanently epilated, which has been treated with the electric pen 8, by using a spheroidal dosage device 11, which is connected electrically to the cathode 6 of the poration machine and is also connected to a vial 12 that contains the liquid solution 10, leaving the anode 7 applied on the opposite part of the body by means of the electrodes 9; this application occurs for approximately at least one minute.

The increase in permeability induced on the skin enormously facilitates the absorption of the molecules of the active ingredient lauryl isoquinolinium bromide at different depths of the dermis, i.e., of the subcutaneous layers of the skin, where the hair bulb resides and is choked and thus inhibited from regrowing.

Finally, to avoid drainage of the liquid solution 10 within the skin, a last step 5 for resting the patient is performed.

The method according to the invention sometimes has to be repeated to obtain complete permanent epilation, allowing a period of time that can vary between two and three weeks to elapse between one treatment and the next. This period is needed for any hair that might have not disappeared permanently to regrow and thus be ready again to be removed by means of the first temporary depilation 1.4.

In fact, for some kinds of people (predominantly those of Mediterranean ethnicity), hairs have rather large roots, which require 2 or 3 epilation processes according to the invention. After each treatment, the hair is born weaker and smaller, and it is therefore possible to achieve a permanent result in a limited number of sessions for any kind of subject to be treated.

It has thus been shown that the invention achieves the proposed aim and objects, and in particular the fact is stressed that a permanent body epilation process in a single session or in any case in a limited number of sessions is provided, with results that have a time validation of no more than three weeks.

In particular, the use of a poration machine with the application of electrodes of opposite polarity allows permeability of the liquid solution in the layer of the skin where the hair follicle is present, and therefore the hair does not regrow because the bulb is suffocated at the root.

Another advantage of the process according to the invention resides in that achieving the goal is only a function of the capacity for permeability of the liquid solution in the dermis and of the size of the hair bulb, and therefore with one or more treatment sessions a permanent epilation on any kind of patient is achieved.

Further, the absence of coagulants or optical rays does not entail risks for the skin and therefore there is no occurrence of drawbacks and skin problems such as rashes, irritations, abrasions, blemishes or otherwise visible marks on the skin.

Not least, the machine employed and the liquid solution are cheap and easily available and therefore the treatment session also has a low cost.

In practice it has been shown that the process thus described allows effective permanent epilation in a limited number of sessions, without any problem of abrasion, irritation or rashes of the skin and without leaving visible marks or blemishes on the skin of the patient.

The invention thus conceived is susceptible of numerous modifications and variations, all of which are within the scope of the appended claims.

All the details may further be replaced with other technically equivalent elements.

In practice, the materials used, as well as the dimensions, may be any according to requirements, so long as they are consistent with the aim.

The disclosures in Italian Patent Application No. AR2008A000002 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-14. (canceled)

15. A permanent body epilation process, comprising a step of skin preparing, for cleansing and degreasing the cutaneous layer of the skin, and a step of applying, by means of a poration machine, a liquid solution that comprises the active ingredient lauryl isoquinolinium bromide.

16. The process according to claim 15, wherein said step for preparing the skin to be treated comprises skin peeling.

17. The process according to claim 15, comprising a drying of the skin.

18. The process according to claim 17, wherein said drying of the skin comprises a drying with talc.

19. The process according to claim 15, wherein said step of preparing the skin to be treated comprises a first temporary depilation.

20. The process according to claim 19, wherein said first temporary depilation comprises an application of a hot liposoluble wax or in any case ensures a cleansed epidermis, a deposition of waxing strips, and a pulling of said strips.

21. The process according to claim 15, further comprising an application of a cathode of said poration machine to the surface of the skin to be treated, and an application of an anode of said poration machine to the opposite side of the surface to be treated with respect to said application of said cathode.

22. The process according to claim 21, further comprising a step of opening the pores of the skin with an electric pen connected to said cathode.

23. The process according to claim 22, wherein said pore opening step has a minimum duration of one minute.

24. The process according to claim 22, wherein said pore opening step occurs in a maximum cutaneous space of five square centimeters.

25. The process according to claim 21, wherein said application of the liquid solution comprises a spreading of said liquid solution with a spheroidal dosage device which is connected electrically to said cathode and is also connected to a vial that contains said liquid solution.

26. The process according to claim 25, wherein said spreading of said liquid solution has a minimum duration of one minute.

27. The process according to claim 22, wherein said spreading of said liquid solution follows said pore opening step and occurs in the same portion of skin treated previously by said pore opening step.

28. The process according to claim 15, further comprising a step of absolute rest of the patient.
